(19) United States
(12) Patent Application Publication
(10) Pub. No.: US 2009/0059245 A1
(43) Pub. Date: Mar. 5, 2009

(54) IMAGE FORMING APPARATUS

(76) Inventor: Shigeo KONUMA, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/144,203

(22) Filed: Jun. 23, 2008

(30) Foreign Application Priority Data
Sep. 3, 2007 (JP) 2007-227375

(51) Int. Cl. G06K 15/02

(52) U.S. Cl. 358/1.2; 358/1.9

(57) ABSTRACT

An image forming apparatus for performing an image formation by synthesizing an additional image to image data, comprises: an image forming section that performs an image formation on a sheet; a display section that displays an additional image to be added to image data; and a control section that displays, on the display section, the additional image based on a position and a size of the additional image to be formed on the sheet to which the image formation is performed, and by a font same as a font of the image formation.

### BACKGROUND OF THE INVENTION

1. Field of the Invention

The present invention relates to an image forming apparatus for performing an image formation on a sheet by adding an additional image.

2. Related Art

An image forming apparatus has a function for performing an image formation on a sheet by adding an additional image such as a stamp image, and so on. Here, the stamp image is an image indicating a comment for the contents of a document, such as e.g. fixed form character of “CONFIDENTIAL TO OUTSIDE OF COMPANY”, “DUPLICATION PROHIBITION”, “COPY”, and so on, or signature, and so on arbitrarily prepared by a user. Also, usually, the image formation is performed at a part of the sheet by one point. The user can easily grasp its attribute without confirming the contents of the document if the stamp image is formed on the received document.

When the stamp image is formed, if the stamp image is the fixed form character, the user performs settings such as form (font, and so on) of the fixed form character, or a position, a size, an area, and so on those are occupied on the sheet by the stamp image. In addition, the setting may be a predetermined setting.

Also, if the stamp image such as signature, and so on are prepared by the user, the user performs settings such as font of a character string, and so on by a predetermined setting screen.

Japanese Patent Laid-Open No. 2000-20271 discloses an image forming apparatus capable of easily setting the above mentioned stamp image prepared by a user. Concretely, it is disclosed to store the stamp image prepared by the user in a predetermined storage section, and display information of the stamp image corresponding to it on a setting screen. Thereby, when the stamp image prepared by the user is formed, it is possible to perform an image formation of a desired stamp image prepared by him/her in easy operations without resetting.

### SUMMARY OF THE INVENTION

However, in the image forming apparatus disclosed in Japanese Patent Laid-Open No. 2000-20271, the stamp image displayed on the setting screen is displayed in a mode different from a mode in which the stamp image is actually formed on a sheet because though the font of the character string of the stamp image is displayed by a monospaced font on the setting screen, the image formation is performed by a proportional font on the sheet. That is, though the fonts, and so on to be used by the image formation are various, only one font is used in many cases of a display of the setting screen because of costs of fonts or a display speed.

Also, it is one of the causes that the resolution of the setting screen is different from an actual image formation.

Accordingly, if the stamp image is formed on the sheet in a mode not desired by the user, the print is waste and the printed waste sheet is produced.

In addition, the above mentioned problem does not occur only about the stamp image prepared by the user, the above mentioned problem occur about the stamp image of the fixed form character. Accordingly, the user can not confirm the font of the stamp image, or the position, the size, the area, and so on those are occupied by the stamp image on the sheet in both the stamp image of the fixed form character and the stamp image prepared by the user without performing actually the image formation.

It is, therefore, a main object of the present invention to an image forming apparatus that displays, on a display section, an additional image capable of recognizing a font, a size and a position those are actually formed on a sheet.

It is, therefore, a first aspect of the present invention to provide an image forming apparatus for performing an image formation by synthesizing an additional image to image data, comprising:

an image forming section that performs an image formation on a sheet;

a display section that displays an additional image to be added to image data; and

a control section that displays, on the display section, the additional image based on a position and a size of the additional image to be formed on the sheet to which the image formation is performed, and by a font same as a font of the image formation.

According to the first aspect of the present invention, the additional image capable of recognizing the font, the position and the size those are actually formed on the sheet is displayed in advance on the display section. Accordingly, it is possible to prevent to form an additional image that is not desired by a user.

### BRIEF DESCRIPTION OF THE DRAWINGS

The above and other objects, advantages and features of the present invention will become more fully understood from the detailed description given below and the appended drawings, and the following descriptions pertain to the embodiment of the present invention are not intended to limit the present invention, and wherein:

FIG. 1 is a functional block diagram of an image forming apparatus;

FIG. 2 is a flowchart showing an operation of the image forming apparatus;

FIG. 3 is a diagram showing an example of a setting screen;

FIG. 4 is a view showing an example of a setting screen;

FIG. 5 is a view showing an example of a setting screen; and

FIG. 6 is a view showing an example of a setting screen.

### DETAILED DESCRIPTION OF THE PREFERRED EMBODIMENTS

In the following embodiments, the features and the operations of an image forming apparatus of the present invention will described in detail with reference to the attached drawings.

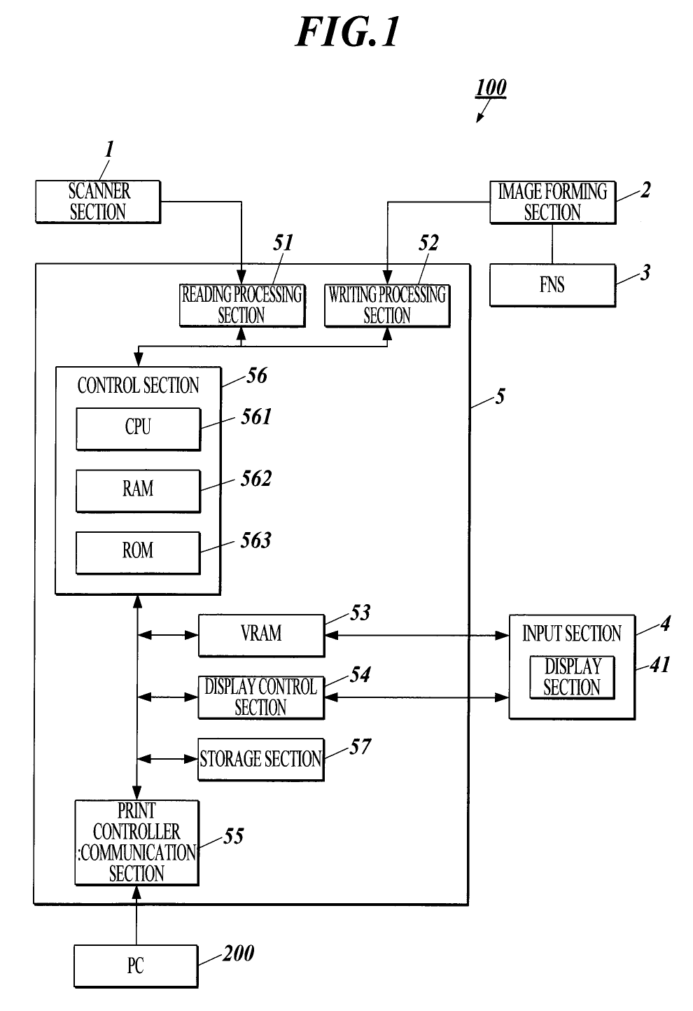

First, in view of FIG. 1, an image forming apparatus 100 relating to this embodiment is explained.

The image forming apparatus 100 is composed of a scanner section 1, an image forming section 2, a FNS (finisher) 3, an input section 4, and a control substrate 5.

The scanner section 1 reads an image of a document, and so on. When reading, a light is firstly emitted to a sheet, the reflected light is detected by a photoelectric conversion equipment such as a CCD (Charged Coupled Device) or a CMOS (Complementary Metal-Oxide Semiconductor), and so on. Then, this analog electric signal is converted to a digital signal (an image signal) by an A/D converter not shown, and the reading is performed by outputting it to a reading processing section 51.

The image forming section 2 is composed of a well known image forming system that performs various kinds of image formations by an electrophotography process, and so on. In addition, the image forming section 2 is not limited to this one, and can adapt to various types of image forming systems such as an ink jetting system, a thermal system, and so on.

The FNS 3 performs a post processing such as staple, inside binding, and so on with respect to a sheet to which the image formation is performed by the image forming section 2.

The input section 4 is composed of a display section 41. The display section 41 is composed of a LCD (Liquid Crystal Display), and so on. Also, the display section 41 has a touch panel (not shown) of an infrared type or an electrostatic type, or various kinds of operation keys (not shown). The input section 4 outputs various kinds of control signals to a control section 56 by operations of a user.

A control substrate 5 is composed of the reading processing section 51, a writing processing section 52, a VRAM (Video Random Access Memory) 53, a display control section 54, a print controller 55 as a communication section, the control section 56, a storage section 57.

The reading processing section 51 performs various processing such as a shading process, and so on to an image signal inputted from the scanner section 1, and output it to the control section 56.

The writing processing section 52 generates print data for an image formation based on inputted image data, and outputs it to the image forming section 2.

The VRAM 53 is a buffer for storing screen data inputted from the control section 56 and transmitting the screen data to the display section 41.

The display control section 54 is composed of a CPU (Central Processing Unit) or a MPU (Micro Processing Unit), and so on, and performs an image display control such as a brightness adjustment of the display section 41, and so on based on a display signal from the control section 56.

The print controller 55 is composed of a LANIF (Local Area Network Interface), and so on. The image forming apparatus 100 is connected to a PC 200 on a network (not shown) via the print controller 55 so as to be capable of communicating each other, and receives a print job transmitted from the PC 200.

The control section 56 is composed of a CPU 561, a RAM (Random Access Memory) 562, a ROM (Read Only Memory) 563, and so on, and performs a centralized control for each section of the image forming apparatus 100. The control section 56 develops a program designated from a system program and various kinds of application programs which are stored on the ROM 563 into a RAM 562, and performs the various processing in cooperation with the program developed in RAM 562 and the CPU 561.

The storage section 57 is composed of HDD (Hard Disk Drive), and so on, and stores various kinds of programs and various kinds of data.

The PC 200 is a widely used PC (Personal Computer). The PC 200 is composed of a CPU, an input section, a RAM, a display section, a storage section, a communication section, and so on (not shown).

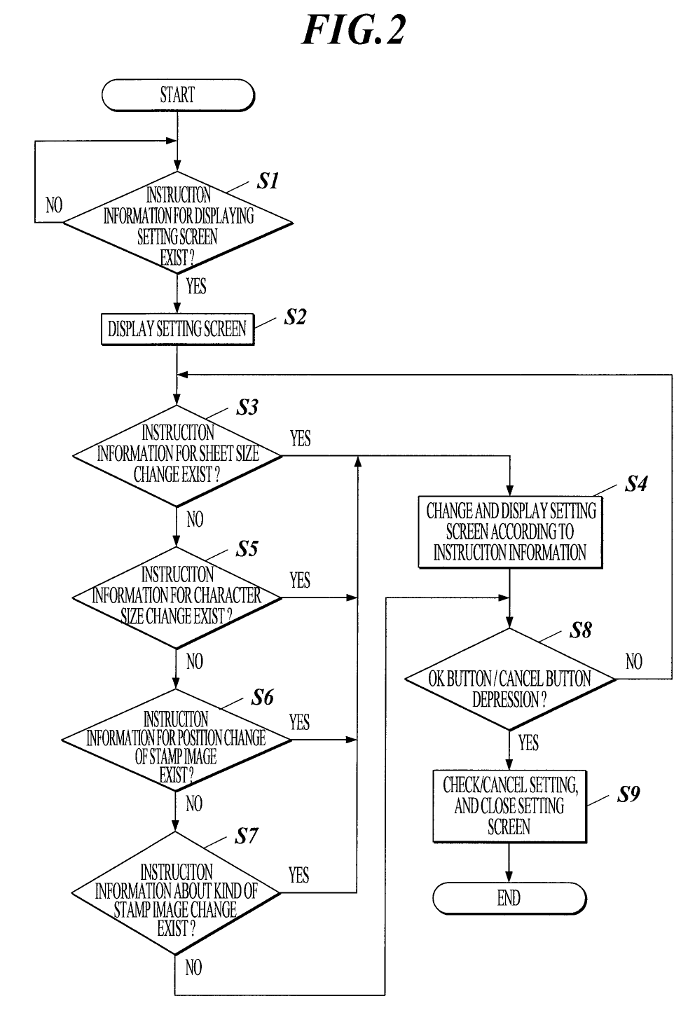

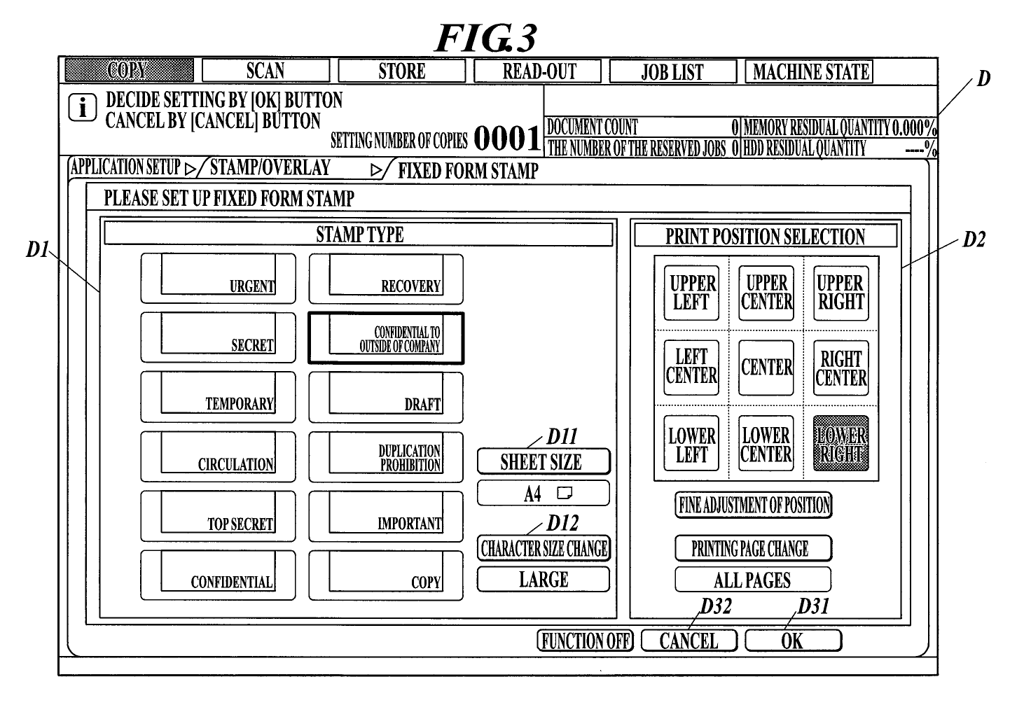

Next, in view of FIG. 2, the operations of the image forming apparatus 100 in this embodiment are explained. Also, FIG. 3 to FIG. 6 show examples of setting screens displayed on the display section 41. Moreover, each process that is explained below is performed in cooperation with the control section 56 and various kinds of programs stored in the storage section 57.

When the control section 56 receives instruction information for instructing a display of the setting screen (step S1; YES), the control section 56 causes the setting screen to be displayed on the display section 41 (step S2). In addition, the setting screen mentioned here is a screen to be displayed when a stamp image is set.

FIG. 3 shows a setting screen D of a stamp image.

The setting screen D is mainly composed of a setting area D1 for selecting the type of a stamp image and a position selection area D2 for inquiring a position for printing.

In the setting area D1, a plurality of stamp images such as “URGENT”, “RECOVERY”, and so on are displayed. Also, in the setting area D1, the sheet size selection button D11 and the character size change button D12 are displayed.

The sheet size selection button D11 is a button for changing a sheet size of a sheet on which the stamp image is formed. Each time the user depresses the sheet size selection button D11, a sheet size shown in a display area that positions under the sheet size selection button D11 is changed and displayed. Here, FIG. 3 shows that the sheet size is set to A4 in a horizontal direction.

The character size change button D12 is a button for changing a font of a character string of the stamp image. Each time the user depresses the character size change button D12, each of “LARGE” and “SMALL” shown in a display area that positions under the character size change button D12 is changed and displayed. Here, FIG. 3 shows that the character size is set to “LARGE”.

In the position selection area D2, position selecting icons for selecting a position of a stamp image on a sheet is displayed. In FIG. 3, the position is set so as to form the stamp image onto a lower right position on the sheet.

Also, in the setting screen D, an OK button D31 and a cancel button D 32 are displayed on a lower right position of a screen.

The OK button D31 is a button for deciding setting contents displayed on the setting screen D. When the OK button D 31 is depressed by the user, the instruction information indicating that the setting contents is decided is outputted to the control section 56. The control section 56 stores the setting contents in the storage section 57 according to the instruction information. On the other hand, cancel button D32 is a button for canceling the setting contents displayed on the setting screen D.

The control section 56 reflects the above mentioned settings in order to all the stamp images displayed on the setting area D1. In addition, the stamp image displayed here is displayed in a bit map form by the control section 56, and the character string is displayed by not the monospaced font but the proportional font. When displaying the stamp image, the control section 56 performs the matching between a resolution of the setting screen and a resolution of the stamp image that is actually formed on the sheet.

Accordingly, the stamp image to be formed on the setting screen D is displayed in a mode in which the image formation is actually performed on the sheet. Also, in the setting screen D, the control section 56 displays the stamp image in the mode in which and the edge of the sheet including the stamp image can be visually confirmed. Thereby, the user can easily grasp the font of the stamp image or the position, the size, the area, and so on those are occupied by the stamp image on the sheet.

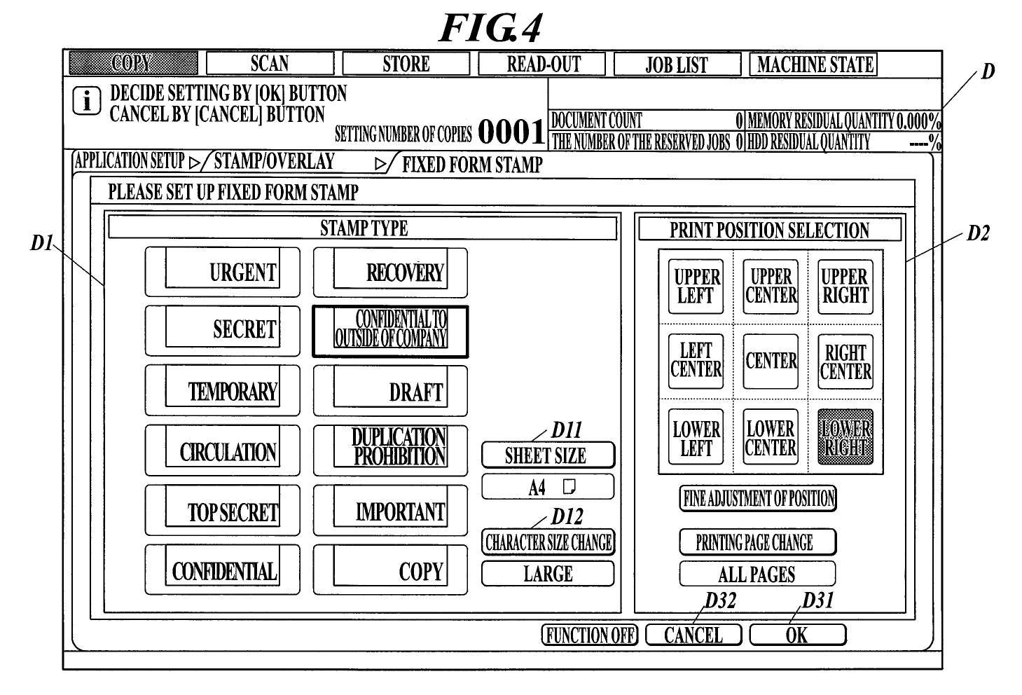

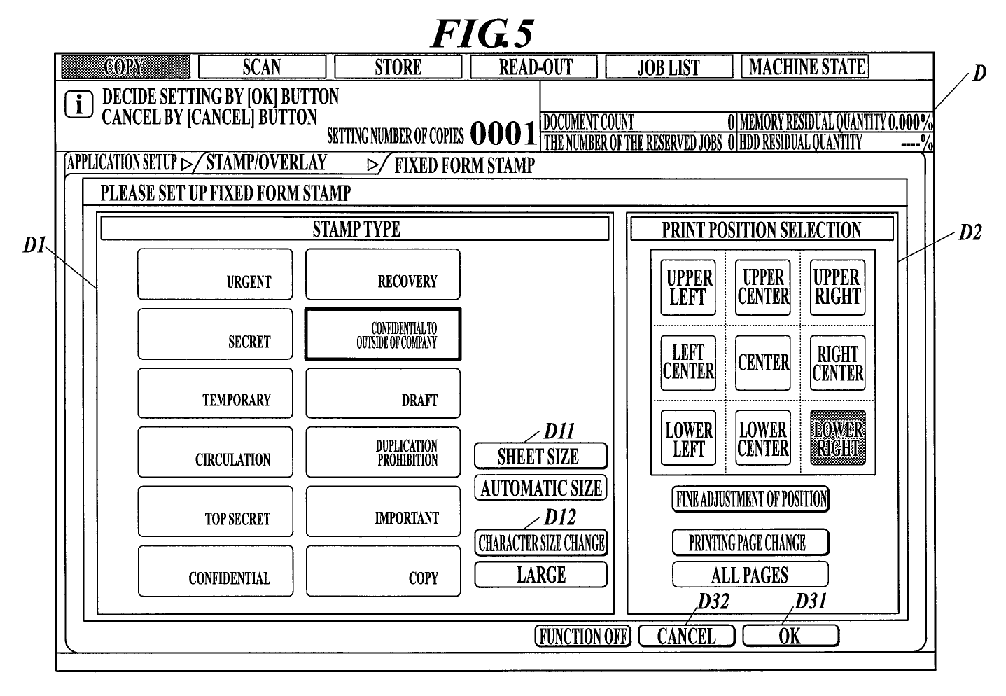

When the control section 56 receives the instruction information for instructing a change of the sheet size via the input section (step S3; YES), the control section 56 displays the stamp image changed according to the instruction information on the setting screen D (step S4). Concretely, the control section 56 changes the setting screen D shown in FIG. 3 to the setting screen D shown in FIG. 4 or FIG. 5.

FIG. 4 shows that “SHEET SIZE” in the setting screen D shown in changed FIG. 3 is changed to “A4” in a vertical direction. In comparison with FIG. 3, the logo mark of the sheet within the display area that positions under the sheet size selection button D11 is changed from the horizontal direction to the vertical direction. Also, when the sheet size is changed to the vertical direction by an operation of the user, the control section 56 changes the display form of the stamp image, and display it. According to this display change, when the user looks at the stamp image in FIG. 4, the user can easily grasp whether the stamp image is set on the sheet in an intended mode or not.

FIG. 5 shows that “SHEET SIZE” in the setting screen D shown in changed FIG. 3 is changed to “AUTOMATIC SIZE”. In comparison with FIG. 3, the display of the display area that positions under the sheet size selection button D11 is changed to the display of “AUTOMATIC SIZE”. Also, the control section 56 displays the stamp image by changing the present mode to the mode in which only the stamp image is displayed without displaying the area (e.g. edge, and so on) of the sheet When the control section 56 receives the instruction information instructing a change of the character size via the input section 4 (step S5; YES), the control section 56 displays the stamp image changed according to the instruction information on the setting screen D (step S4). After the character size is changed, the stamp image becomes the same outside view in comparison with the outside view of the stamp image shown in FIG. 3 to FIG. 5.

When the control section 56 receives the instruction information instructing a change of the position of the stamp image via the input section 4 (step S6; YES), the control section 56 displays the stamp image changed according to the instruction information on the setting screen D (step S4).

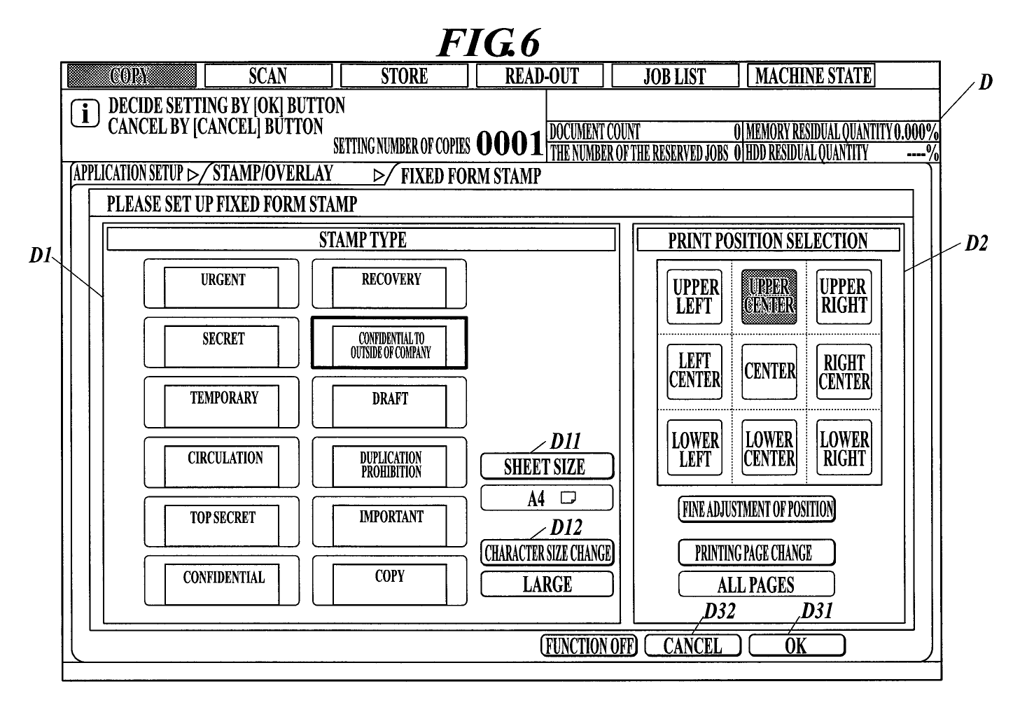

FIG. 6 shows the setting screen D in which the position of the stamp image is changed. In comparison with FIG. 3, the position of the stamp image on the sheet is changed and displayed. In addition, in FIG. 6, the stamp image is set so as to form it on the position in the upper center portion on the sheet.

When the control section 56 receives the instruction information instructing the change of a kind of the stamp image via the input section 4 (step S7; YES), the control section 56 discriminates the selected stamp image according to the instruction information, and display it. Concretely, the outer frame of the selected stamp image is displayed so as to enclose it by a thick line. In the setting screen D of FIG. 3 to FIG. 6, “CONFIDENTIAL TO OUTSIDE OF COMPANY” is selected in any of the stamp images.

When the control section 56 receives the instruction information indicating the decision that after receiving the instruction information of the above mentioned stamp images (step S8; YES), the control section 56 decides the setting of the stamp image (step S9), and finish the process. In addition, concretely, when the user depresses the OK button D31 on the setting screen D, the control section 56 receives the instruction information instructing the decision via the input section 4.

Also, in step S8, when the instruction information indicating the cancellation, the control section 56 cancels the former settings (step S9), and finishes the process.

As mentioned above, in accordance with a first aspect of the preferred embodiments of the present invention, an image forming apparatus 100 for performing an image formation by synthesizing an additional image to image data, comprises:

an image forming section 2 that performs an image formation on a sheet;

a display section 41 that displays an additional image to be added to image data; and

a control section 56 that displays, on the display section 41, the additional image changed based on a position and a size of the additional image to be formed on the sheet to which the image formation is performed, by a font same as a font of the image formation.

According to this image forming apparatus 100, the user can grasp the mode before the stamp image is formed on the sheet.

Also, preferably, the image forming apparatus 100 has the control section 56 that displays an area including the additional image to be formed on the sheet.

According to the image forming apparatus 100, the user looks at the stamp image displayed on the setting screen D, and can easily grasp the stamp image in the mode in which the stamp image is actually formed on the sheet. Accordingly, it is possible to prevent producing the printed waste sheet.

Further, preferably, the image forming apparatus 100 comprises an input section 4 for inputting an image formation condition, wherein the additional image to be displayed on the display section is composed of one or more additional images, and the control section changes in a same way a size and/or a position of the one or more additional images displayed on the display section 41 based on the image formation condition inputted from the input section 4.

According to the image forming apparatus 100, it is not necessary to individually set for each of the stamp images, and it is possible to improve the operability.

Further, preferably, the image forming apparatus 100 has the control section 56 that displays, on the display section 41, the additional image in a whole image corresponding to a size of the sheet.

According to the image forming apparatus 100, the user can easily grasp the position, the size, the area, and so on those are occupied by the stamp image on the sheet.

Further, preferably, in the image forming apparatus 100, the image formation condition is a type of display contents of the additional image, a font type, a print position, a size or a color.

According to the image forming apparatus 100, it is possible to confirm the stamp image actually to be formed on the sheet.

Further, preferably, in the image forming apparatus 100, the additional image includes a stamp image, and may be adapted to e.g. a digital watermarking image or water mark.

According to the image forming apparatus 100, the user can grasp the outside view with respect to the additional image displayed on the setting screen D without actually performing the image formation.

In addition, the entire disclosure of Japanese Patent Applications No. 2007-227375 filed on Sep. 3, 2007 including specifications, claims, drawings and summaries are incorporated herein by reference in their entirety.

What is claimed is:

1. An image forming apparatus for performing an image formation by synthesizing an additional image to image data, comprising:
an image forming section that performs an image formation on a sheet;
a display section that displays an additional image to be added to image data; and
a control section that displays, on the display section, the additional image changed based on a position and a size of the additional image to be formed on the sheet to which the image formation is performed, by a font same as a font of the image formation.

2. The image forming apparatus according to claim 1, wherein the control section displays an area including the additional image to be formed on the sheet.

3. The image forming apparatus according to claim 1, further comprising:
an input section for inputting an image formation condition, wherein
the additional image to be displayed on the display section is composed of one or more additional images, and
the control section changes in a same way a size and/or a position of the one or more additional images displayed on the display section based on the image formation condition inputted from the input section.

4. The image forming apparatus according to claim 1, wherein the control section displays the additional image in a whole image corresponding to a size of the sheet on the display section.

5. The image forming apparatus according to claim 3, wherein the image formation condition is a type of display contents of the additional image, a font type, a print position, a size or a color.

6. The image forming apparatus according to claim 1, wherein the additional image is a stamp image.

7. The image forming apparatus according to claim 1, wherein the additional image is a digital watermarking image.
